(19) United States
(12) Patent Application Publication
(10) Pub. No.: US 2026/0177294 A1
(43) Pub. Date: Jun. 25, 2026

(54) HYBRID SOLAR AND BATTERY POWERED THERMOELECTRIC COOLER

(71) Applicant: Luya Labs Inc., Dover, DE (US)

(72) Inventor: Joseph Manuel Luya, Orlando, FL (US)

(21) Appl. No.: 19/424,728

(22) Filed: Dec. 18, 2025

Related U.S. Application Data
(60) Provisional application No. 63/736,267, filed on Dec. 19, 2024.

(51) Int. Cl. F25B 27/00; F25B 21/04; H02S 10/40

(52) U.S. Cl. CPC F25B 27/002; F25B 21/04; H02S 10/40; F25B 2321/0212; F25B 2700/2104

(57) ABSTRACT

A thermoelectric cooler includes a hybrid power architecture that provides active cooling and heating. The cooler includes a body defining an internal storage space and a lid housing thermoelectric modules coupled to a cooling and heating plate. A rechargeable battery supplies power to the thermoelectric modules and is chargeable by an integrated solar panel or an external alternating current source through a power conversion module. A controller manages power distribution and regulates operation of the thermoelectric modules to maintain a selected temperature within the internal storage space. In some embodiments, multiple thermoelectric modules are independently controlled to enable different temperature zones within the cooler, including simultaneous cooling and heating. The lid-integrated thermal architecture preserves internal storage volume while enabling efficient heat dissipation. Wireless communication and user interface features may be provided for monitoring and control. The system enables portable, energy-efficient, and off-grid temperature regulation without reliance on ice or refrigerants.

### RELATED APPLICATIONS

This application claims the benefit of U.S. Provisional Application Serial No. 63/736,267 filed December 19, 2024, which is hereby incorporated herein in its entirety by reference.

### TECHNICAL FIELD

The present invention relates to the field of portable cooling devices, and, more particularly, to a hybrid solar and battery powered thermoelectric cooler.

### BACKGROUND

Traditional insulated coolers, while widely used for recreational and commercial purposes, have several inherent limitations. Such coolers operate passively by relying on ice or frozen packs to maintain a reduced temperature environment. Once the ice melts or the frozen packs lose their thermal mass, the cooling effect diminishes rapidly because traditional coolers do not actively cool contents but instead only delay warming. In hot climates or during extended use, the need to replenish ice frequently creates inconvenience and cost, particularly in situations where access to ice is limited.

Another limitation of conventional coolers is uneven temperature distribution. Items placed in direct contact with ice remain colder, while items positioned away from the ice often warm more quickly. Because these coolers lack active temperature control, the user has no ability to regulate or adjust internal temperature in a precise manner. In addition, the combined weight of ice and stored items makes such coolers heavy to lift and transport, and to extend cooling duration, users often employ oversized coolers that are bulky and less portable.

The presence of melting ice also creates practical problems. Meltwater collects at the bottom of the cooler, submerging non-waterproof items and compromising food quality. While some coolers incorporate drain plugs, these may leak, require manual draining, or be subject to clogging and wear over time. Further, the insulating materials used in traditional coolers can degrade after repeated thermal cycling and environmental exposure. Over time, seals, hinges, and plastic components may crack or lose integrity, reducing overall effectiveness.

From an environmental standpoint, the use of ice presents additional concerns. The production, storage, and transportation of ice require significant amounts of energy, contributing to greenhouse gas emissions and increasing reliance on fossil-fuel-based infrastructure. For extended outdoor use, the repeated purchase and replenishment of ice also increases cost and waste, adding to the burden of single-use plastic bags or containers used for ice storage and handling.

Portable compressor-based refrigeration systems have been proposed as an alternative, but these are generally expensive, heavy, noisy, and rely on refrigerants with potential environmental impact. They also require high power input and are less suited for extended off-grid applications where renewable or stored energy is limited.

Accordingly, there remains a need in the art for a cooling system that addresses the shortcomings of traditional insulated coolers and compressor-based portable refrigerators. Specifically, what is needed is a portable cooler that operates without ice, provides consistent and controllable cooling, reduces overall weight, improves portability, and eliminates the problems associated with meltwater. Further, such a system should be energy-efficient, environmentally friendly, and capable of sustained off-grid use, making it particularly suitable for outdoor recreation, extended travel, emergency relief, and commercial applications.

### SUMMARY

A thermoelectric cooler is disclosed. In one embodiment, the thermoelectric cooler includes a body defining an internal storage space and a lid coupled to the body and movable between an open position and a closed position. At least one thermoelectric module is provided, the thermoelectric module having a cold side and a hot side. A cooling plate is in thermal communication with the cold side of the thermoelectric module and is oriented toward the internal storage space when the lid is closed. A heat sink is in thermal communication with the hot side of the thermoelectric module to dissipate heat away from the internal storage space.

The thermoelectric cooler further includes a rechargeable battery and a solar panel electrically coupled to the rechargeable battery. A power supply module is provided that is configured to receive external alternating current and convert the alternating current into direct current. A controller is operatively coupled to the thermoelectric module, the rechargeable battery, the solar panel, and the power supply module. The controller is configured to selectively supply operating power to the thermoelectric module from the solar panel, the rechargeable battery, the power supply module, or combinations thereof, in order to regulate a temperature within the internal storage space.

In another embodiment, the thermoelectric cooler includes a lid enclosing the internal storage space, where an insulation panel is positioned within the lid. A cooling and heating plate is secured to the insulation panel and faces the internal storage space. A plurality of thermoelectric modules are positioned within the lid, each thermoelectric module having a cold side in thermal communication with the cooling and heating plate and a hot side thermally coupled to a corresponding heat sink. A controller is configured to independently control electrical power supplied to each thermoelectric module.

In certain embodiments, the thermoelectric cooler further includes at least one removable divider configured to partition the internal storage space into multiple compartments. The controller may be configured to maintain different temperatures in different compartments, including embodiments in which at least one thermoelectric module operates in a cooling mode while another thermoelectric module operates in a heating mode.

The invention further includes methods of controlling temperature within a thermoelectric cooler, including supplying electrical power to at least one thermoelectric module from a rechargeable battery, generating electrical power using a solar panel electrically coupled to the rechargeable battery, selectively charging the rechargeable battery using either the solar panel or an external alternating current source, transferring heat between the internal storage space and the cooling and heating plate using the thermoelectric module, and regulating operation of the thermoelectric module using the controller to maintain a selected temperature.

Accordingly, the present invention delivers a portable cooling solution that combines renewable energy harvesting, intelligent thermal management, uniform lid-based cooling, and smart connectivity. These features provide non-obvious advantages over existing coolers by extending runtime, preserving storage space, and enabling precise, user-controlled refrigeration in a variety of applications.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a thermoelectric cooler with a lid in a closed position;

FIG. 2 is a perspective view of the thermoelectric cooler with the lid in an open position, showing access to an interior container space;

FIG. 3 is a top plan view of the lid illustrating an integrated solar panel;

FIG. 4 is an interior view of the lid showing thermoelectric cooling components housed within the lid, including a cooling plate, thermoelectric modules, heat sinks, and associated electronics;

FIG. 5 is a bottom view of the lid showing an underside configuration relative to the interior of the cooler;

FIG. 6 is an elevational view of the lid;

FIG. 7 is an interior view of a cooler body showing sidewalls and a bottom defining the container space;

FIG. 8 is a bottom perspective view of the cooler body; and

FIG. 9 is a cross-sectional view of the cooler body illustrating wall construction and insulating materials.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

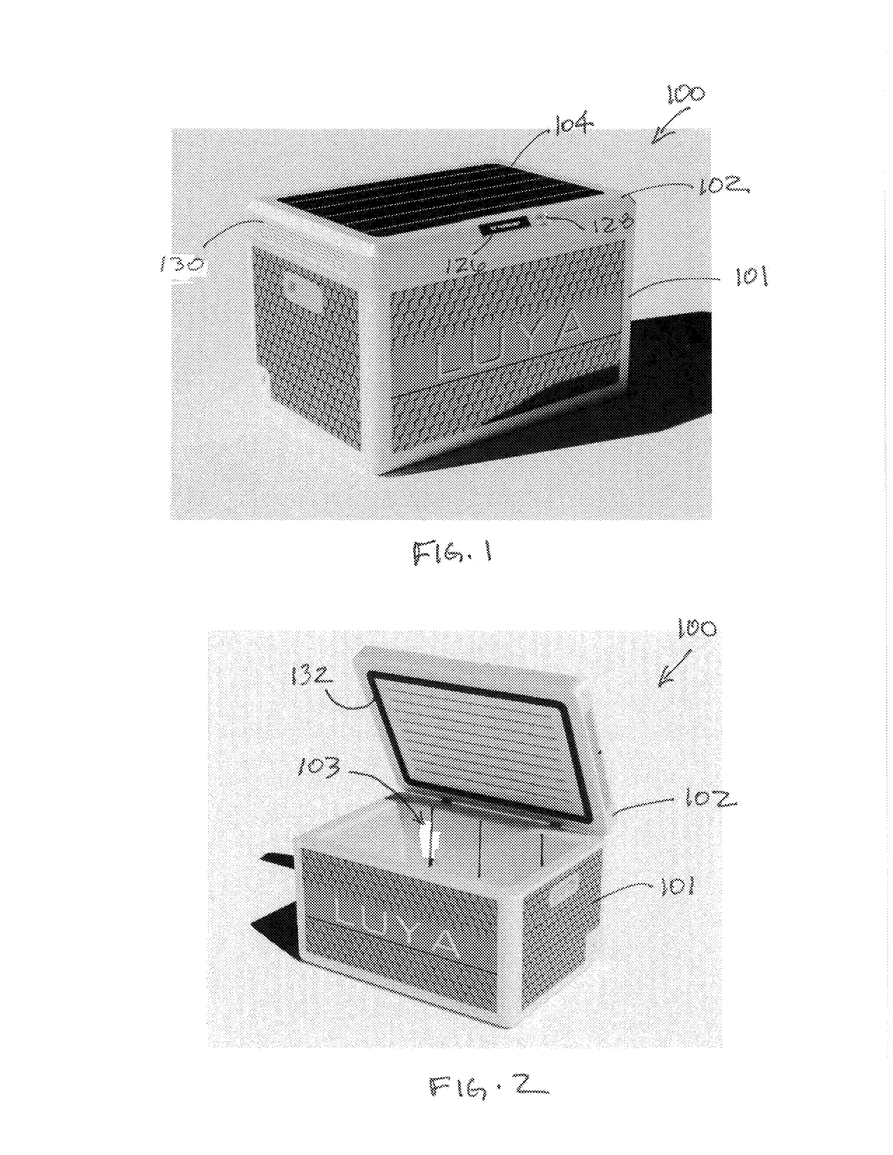

Referring now to FIG. 1, a thermoelectric cooler 100 is shown in a closed configuration. The thermoelectric cooler 100 includes a body 101 and a lid 102 cooperatively forming an enclosed internal space 103. The body 101 defines a generally box-shaped structure having insulated sidewalls and a bottom configured to support contents stored within the internal space 103. The body 101 may be formed from a rigid polymeric material selected for durability, impact resistance, and thermal insulation, making the cooler suitable for outdoor and mobile use.

The lid 102 is positioned on an upper end of the body 101 and is configured to selectively open and close relative to the body 101. In the closed position shown in FIG. 1, the lid 102 seals the internal space 103 to reduce thermal exchange with the external environment. A gasket 132 is disposed along a mating interface between the lid 102 and the body 101. The gasket 132 may be formed from an elastomeric material and is configured to provide an airtight and liquid-resistant seal when the lid 102 is closed, thereby improving thermal efficiency and preventing ingress of moisture or contaminants.

As further shown in FIG. 1, a solar panel 104 is mounted on an exterior upper surface of the lid 102. The solar panel 104 is positioned to receive incident sunlight when the cooler 100 is placed outdoors and is electrically coupled to an internal power supply. In certain embodiments, the solar panel 104 may be recessed into the lid 102, flush-mounted, or raised slightly above the lid surface to reduce shading and improve solar exposure. The placement of the solar panel 104 on the lid 102 allows power generation without increasing the footprint of the cooler.

The lid 102 may further include one or more ventilation openings or louvers 130 formed in an exterior surface of the lid. The louvers 130 are configured to permit airflow into and out of the lid interior to support heat dissipation from internal components, while limiting direct exposure to rain, debris, or splashed liquids. The louvers 130 may be arranged along side or rear portions of the lid 102 to promote convective airflow during operation.

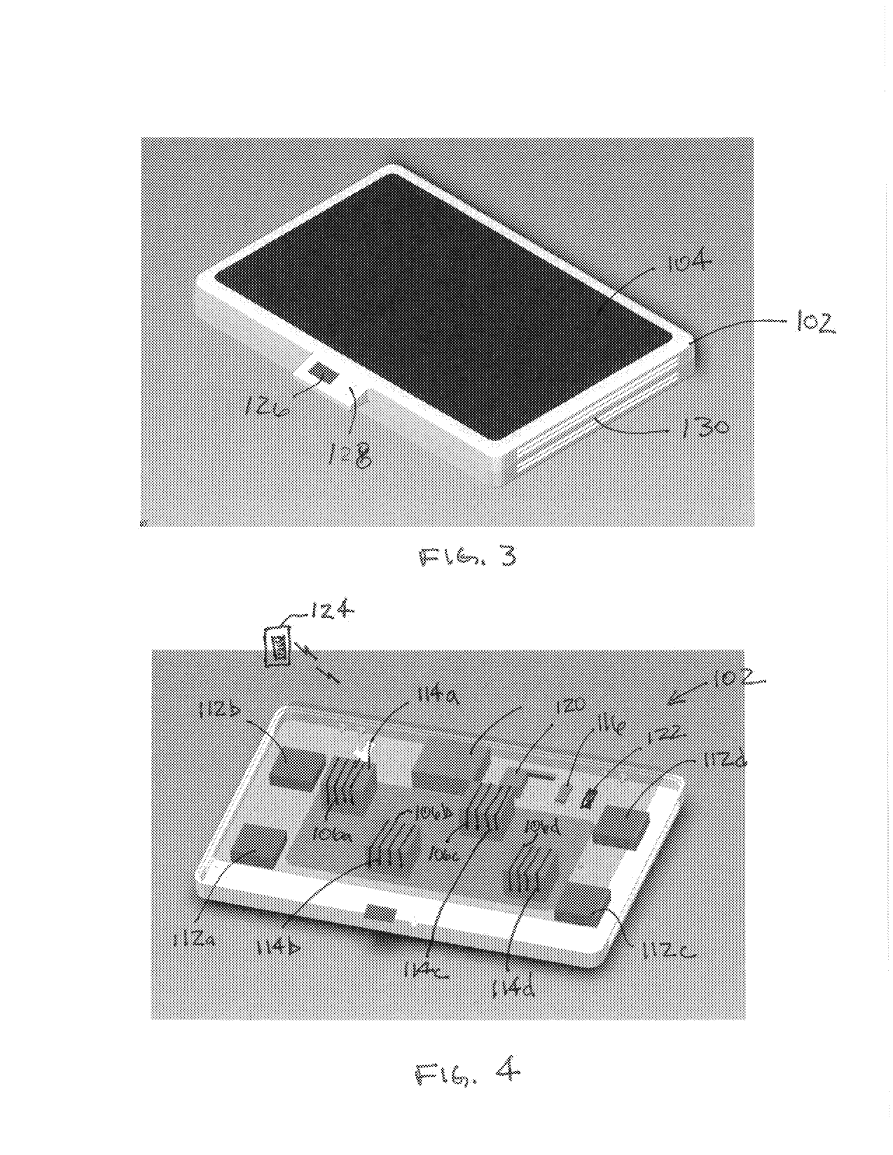

Referring now to FIG. 2, the thermoelectric cooler 100 is shown with the lid 102 in an open position. In this configuration, the internal space 103 defined by the body 101 is accessible to a user for loading or removing contents. The lid 102 may be hingedly coupled to the body 101 along one side, or alternatively may be fully removable, depending on the desired configuration.

The internal space 103 is sized to receive food items, beverage containers, medical supplies, or other temperature-sensitive contents. The interior surfaces of the body 101 may be smooth and moisture-resistant to facilitate cleaning and hygiene. In some embodiments, internal guide features or slots may be formed within the body 101 to receive removable dividers, as described in further detail with respect to later figures.

With the lid 102 open, the interior-facing components of the lid are positioned above the internal space 103. When the lid 102 is closed during operation, these components provide active thermal regulation to the internal space 103 without occupying usable storage volume within the body 101. This lid-based configuration preserves internal capacity while enabling active cooling and heating functionality.

FIG. 2 further illustrates the relationship between the lid 102 and the body 101 during normal use. When the lid 102 is opened, airflow into the internal space 103 is permitted, and when the lid 102 is closed, the gasket 132 forms a sealed interface that limits air exchange. This configuration allows rapid access to contents while maintaining efficient temperature control during closed operation.

Accordingly, FIGS. 1 and 2 together illustrate the external form, access configuration, and overall structural arrangement of the thermoelectric cooler 100, highlighting the integration of renewable power generation, sealed thermal containment, and user accessibility within a portable cooling system.

Referring now to FIG. 3, a top plan view of the lid 102 of the thermoelectric cooler 100 is shown. The lid 102 includes an exterior upper surface configured to support and protect a solar panel 104. The solar panel 104 may be rigidly mounted to the lid 102 or integrated into a recessed portion of the lid to reduce protrusion and protect the panel from impact. In certain embodiments, the solar panel 104 is laminated beneath a transparent protective layer formed from tempered glass or a polymeric material to resist scratching, moisture ingress, and ultraviolet degradation.

The solar panel 104 is electrically coupled to internal power circuitry housed within the lid 102 or body of the cooler. Conductive pathways may extend through sealed channels or grommets in the lid 102 to route electrical connections from the solar panel 104 to the power supply 118 and controller 116. These sealed pathways prevent moisture intrusion while maintaining electrical reliability during outdoor use.

In some embodiments, the lid 102 further includes an integrated user interface on its exterior surface. The user interface may include a display screen 126 and one or more control buttons 128. The screen 126 may be configured to display real-time temperature information, selected operating modes, power status, and alerts. The buttons 128 allow a user to manually adjust temperature setpoints, switch between cooling and heating modes, or place the cooler into an energy-saving mode. The user interface components may be sealed beneath a weather-resistant membrane to allow operation in wet or dusty environments.

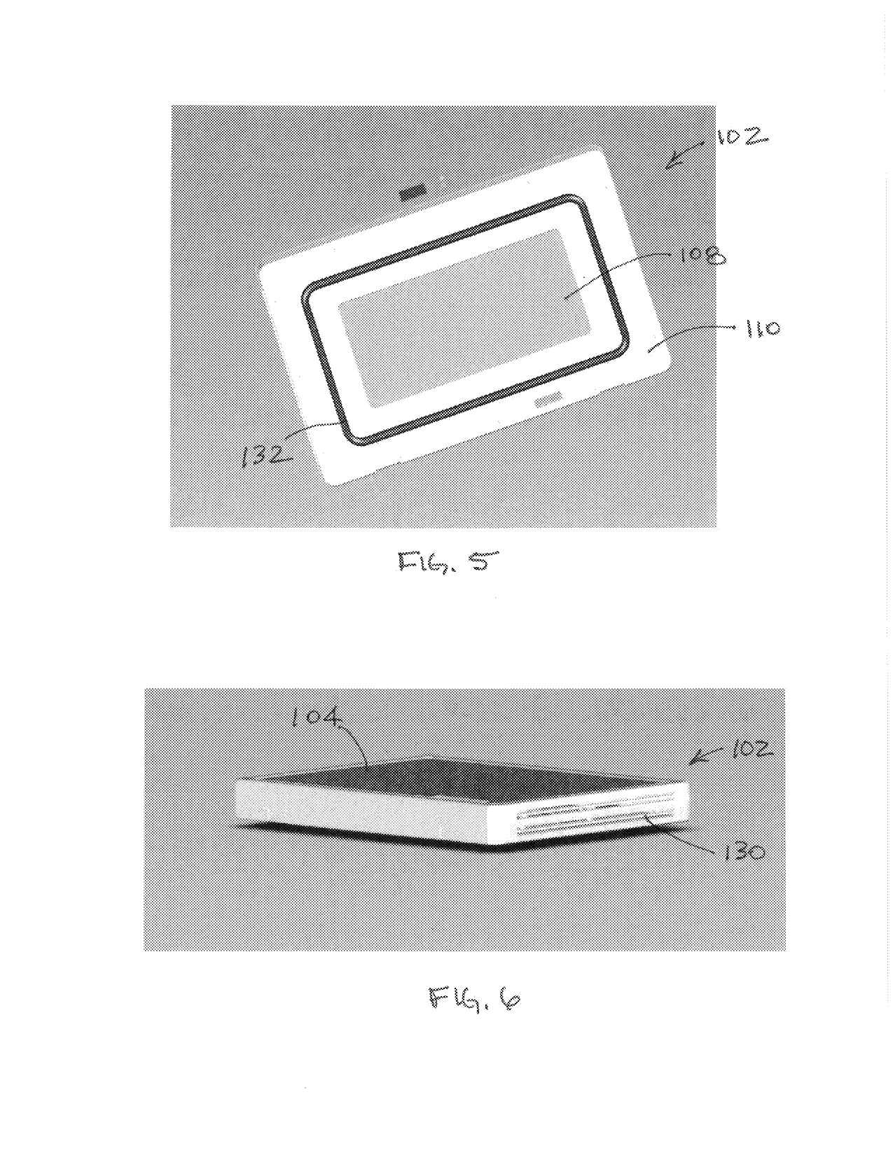

Referring now to FIG. 4, an interior view of the lid 102 is shown with the lid oriented to expose internal components. The lid 102 houses the primary thermal management system of the thermoelectric cooler 100. An insulation panel 110 is positioned within the lid and separates the interior-facing cooling components from the exterior surface of the lid. The insulation panel 110 reduces heat transfer between the external environment and the internal space 103, thereby increasing cooling efficiency and reducing power consumption.

A cooling and heating plate 108 is mounted to an interior-facing surface of the insulation panel 110. The plate 108 is oriented to face the internal space 103 when the lid 102 is closed and serves as the primary thermal interface between the thermoelectric system and the contents of the cooler. The plate 108 may be formed from aluminum, copper, or a composite material selected for high thermal conductivity and uniform heat distribution. In certain embodiments, the plate 108 extends across a majority of the lid’s interior surface to minimize temperature gradients within the internal space.

A plurality of thermoelectric modules 114a, 114b, 114c, 114d are positioned within the lid 102 and are sandwiched between the cooling and heating plate 108 and corresponding heat sinks 106a, 106b, 106c, 106d. Each thermoelectric module operates based on the Peltier effect and includes a cold side thermally coupled to the plate 108 and a hot side thermally coupled to one of the heat sinks. When electrical current is applied in a first direction, heat is transferred from the plate 108 to the heat sink, thereby cooling the internal space 103. When the current direction is reversed, heat is transferred toward the plate 108, allowing the internal space to be heated.

The heat sinks 106a–106d are positioned on an exterior-facing side of the insulation panel 110 and are configured to dissipate heat generated by the thermoelectric modules. Each heat sink may comprise a finned metallic structure designed to maximize surface area and convective heat transfer. The heat sinks are arranged within the lid 102 to align with ventilation openings 130, enabling efficient airflow through the lid.

A plurality of fans 112a, 112b, 112c, 112d are associated with the heat sinks 106a–106d. The fans are configured to actively move ambient air across the heat sinks during operation to enhance heat dissipation. The fans may be individually controlled by the controller 116, allowing fan speed or activation to be adjusted based on temperature, power availability, or operating mode.

Electrical power to the thermoelectric modules 114a–114d and fans 112a–112d is regulated by the controller 116. The controller may independently control each thermoelectric module, allowing localized thermal management across different regions of the cooling and heating plate 108. This independent control supports multi-zone operation when used in combination with removable dividers in the body, as described in later figures.

The lid 102 thus functions as a self-contained thermal management assembly, integrating solar energy harvesting, active thermoelectric cooling and heating, heat dissipation, and user controls. By housing these components within the lid, the thermoelectric cooler 100 maximizes usable storage volume within the body while simplifying maintenance and assembly.

Referring now to FIG. 5, a bottom view of the lid 102 of the thermoelectric cooler 100 is shown. The bottom surface of the lid 102 faces the internal space of the cooler when the lid is in the closed position. The cooling and heating plate 108 is exposed on the bottom surface and is positioned to face downward toward the internal space. In this configuration, the plate 108 serves as the primary thermal interface between the thermoelectric system housed within the lid and the contents stored within the cooler.

The bottom surface of the lid 102 may include a generally planar region surrounding the cooling and heating plate 108, allowing the plate to be flush-mounted or slightly recessed relative to the surrounding lid structure. This arrangement protects the plate 108 from direct impact during loading and unloading while still enabling efficient heat transfer through natural convection and radiant exchange within the internal space.

A peripheral sealing region is formed around the bottom surface of the lid 102, corresponding to the location of the gasket 132. The gasket 132 may be seated within a groove or channel formed in the lid 102 or the body of the cooler. When the lid 102 is closed, the gasket 132 compresses against a mating surface on the body to form a substantially airtight seal. This seal reduces air leakage, limits moisture ingress, and enhances the overall thermal performance of the thermoelectric cooler.

The underside of the lid 102 may further include structural reinforcement features such as ribs, bosses, or recessed mounting regions. These features provide mechanical support for internal components mounted within the lid, including the insulation panel, cooling and heating plate, thermoelectric modules, and heat sinks. The reinforced structure also improves resistance to warping or deformation that could otherwise compromise the lid seal or thermal alignment.

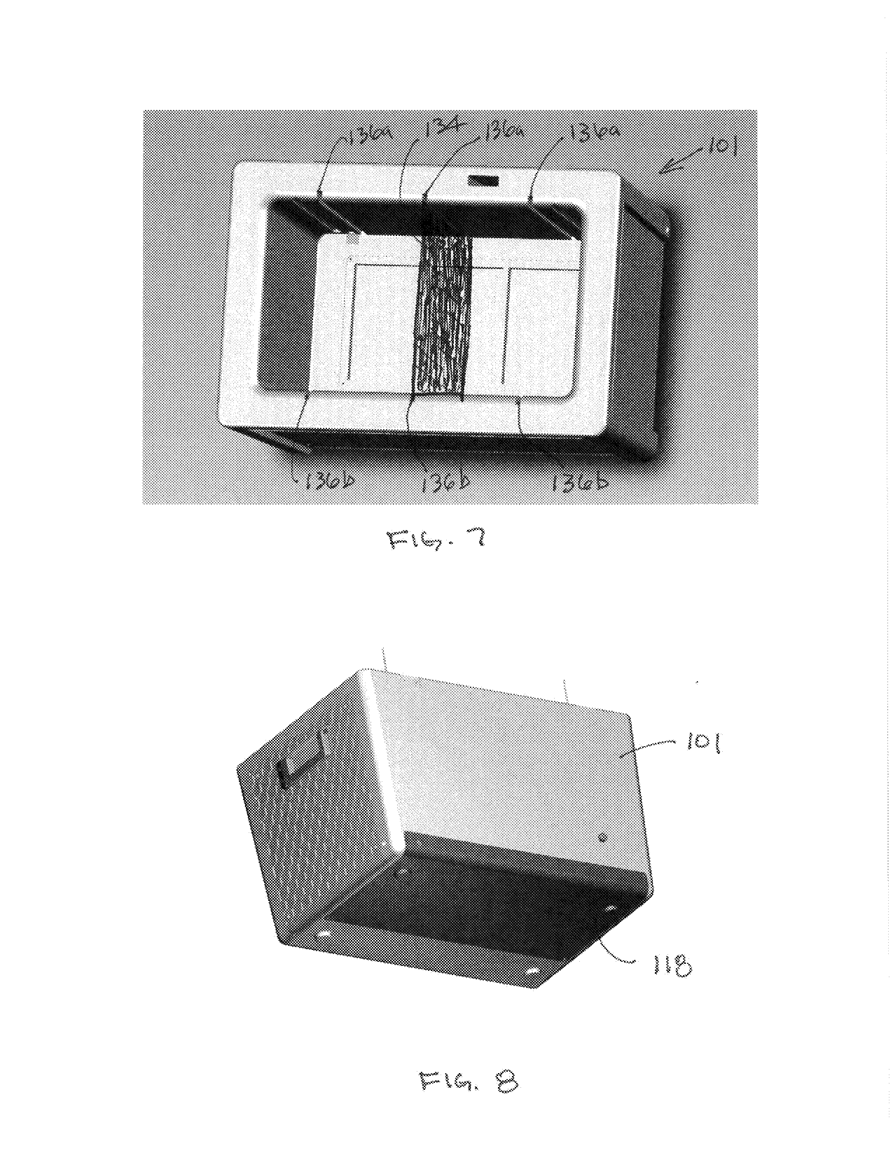

Referring now to FIG. 6, an elevational view of the lid 102 is shown. The lid 102 includes an exterior profile configured to accommodate internal components while maintaining a compact and ergonomic form factor. The thickness of the lid may vary to house the thermoelectric modules, heat sinks, fans, and insulation while still allowing the lid to sit flush on the body of the cooler when closed.

FIG. 6 further illustrates the positioning of airflow openings or louvers 130 along one or more exterior surfaces of the lid 102. The louvers 130 are arranged to permit ambient air to flow into and out of the lid interior, thereby enabling effective cooling of the heat sinks and thermoelectric modules. The orientation of the louvers may be selected to minimize direct exposure to rain, splashes, or debris while still providing sufficient airflow for thermal dissipation.

The elevational view also illustrates the relative position of the solar panel mounted on the upper surface of the lid and the cooling and heating components housed within the lid. This layered configuration allows solar energy harvesting, thermal management, and user interaction to be integrated into a single lid assembly without interfering with access to the internal storage space of the cooler body.

In certain embodiments, the lid 102 may include integrated handles, hinge mounts, or latch features formed as part of the lid structure. These features may be positioned to avoid interference with the solar panel, airflow openings, and internal thermal components. The lid may be removably attached, hingedly connected, or secured using latches, depending on the desired configuration.

Accordingly, FIGS. 5 and 6 illustrate the functional relationship between the underside of the lid, the sealing interface with the cooler body, and the exterior geometry of the lid. Together, these features enable efficient thermal transfer to the internal space, effective heat rejection to the environment, and durable, weather-resistant operation of the thermoelectric cooler.

Referring now to FIG. 7, an interior view of the thermoelectric cooler 100 is shown with the lid removed or opened to expose the internal structure of the body 101. The body 101 defines the internal space 103, which is configured to receive items requiring temperature control. The interior surfaces of the body 101 may be formed from a smooth, moisture-resistant material to facilitate cleaning and to prevent absorption of liquids or odors.

The internal space 103 includes one or more divider slots 136a, 136b formed in opposing interior sidewalls of the body 101. The slots 136a, 136b are vertically oriented and configured to removably receive a divider 134. The divider 134 may be formed from a thermally insulating or thermally resistive material and is sized to extend between the bottom of the body and the underside of the lid when the lid is closed. When inserted, the divider 134 subdivides the internal space 103 into two or more compartments.

In certain embodiments, the divider 134 includes sealing edges or flexible gaskets along its perimeter to limit airflow between adjacent compartments. This configuration enables thermal isolation between compartments and allows different regions of the internal space 103 to be maintained at different temperatures. For example, one compartment may be cooled while another compartment is heated, or different compartments may be maintained at different cooling setpoints.

The multi-zone capability is supported by independent control of the thermoelectric modules housed within the lid. The controller selectively energizes specific thermoelectric modules associated with different regions of the cooling and heating plate, enabling targeted thermal regulation aligned with the positions of the dividers. This feature allows the thermoelectric cooler to function as a combination refrigerator and warmer within a single enclosure.

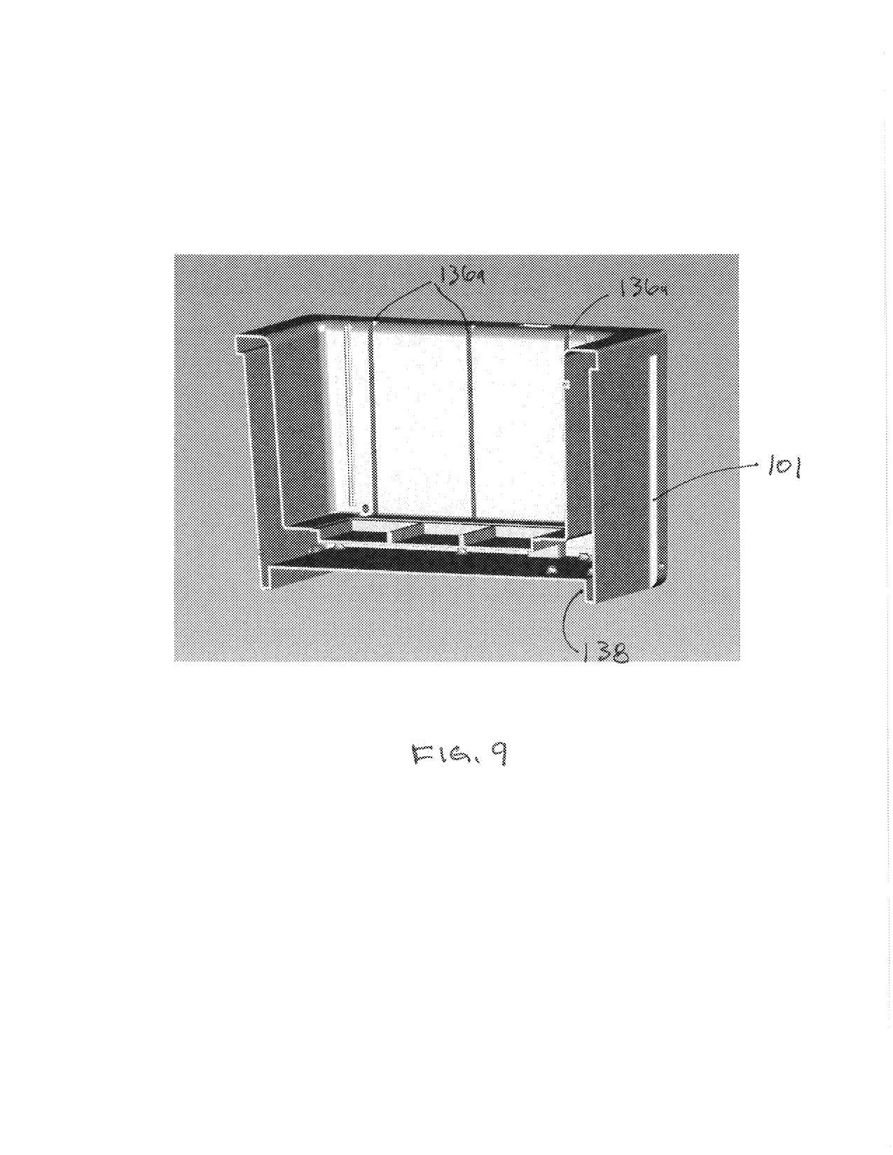

Referring now to FIG. 8, a bottom perspective view of the body 101 is shown. The bottom of the body includes a battery slot 138 formed therein. The battery slot 138 is configured to receive a removable power supply 118, such as a rechargeable battery pack. Positioning the battery at the bottom of the body lowers the center of gravity of the cooler, improving stability during transport and use.

The battery slot 138 may include a cover or access panel that allows the battery to be removed or replaced without disassembling the cooler. Electrical contacts within the battery slot provide power to the controller, thermoelectric modules, fans, and associated electronics. In certain embodiments, the battery slot may also include ventilation features to allow heat generated by the battery to dissipate safely.

Referring now to FIG. 9, a cross-sectional view of the body 101 is shown. The cross-section illustrates the layered construction of the body, including an exterior shell, an insulation layer, and an interior liner defining the internal space 103. The insulation layer may comprise closed-cell foam, vacuum-insulated panels, or other high-performance insulating materials selected to minimize heat transfer and improve energy efficiency.

FIG. 9 further illustrates the relationship between the internal space 103 and the battery slot 138. The battery slot is thermally isolated from the internal space by one or more insulation layers, preventing heat generated by the battery from adversely affecting stored contents. Electrical wiring between the battery and the lid-mounted components may be routed through insulated channels formed within the body.

The cross-sectional view also illustrates the sealing interface between the body and the lid, including the gasket positioned along the upper perimeter of the body. When the lid is closed, the gasket forms a compressed seal that limits air exchange and moisture ingress, further enhancing thermal performance and protecting internal components.

In combination, FIGS. 7-9 illustrate how the body of the thermoelectric cooler supports multi-zone temperature control, secure and accessible battery storage, and high-performance insulation. These features cooperate with the lid-mounted thermal management system to provide a versatile, energy-efficient, and portable cooling and heating solution.

The thermoelectric cooler 100 further includes control logic implemented by the controller 116, which manages operation of the thermoelectric modules, fans, power sources, and user interfaces. The controller 116 may comprise a microcontroller or microprocessor executing stored instructions and interfacing with temperature sensors, power management circuitry, and communication modules.

One or more temperature sensors may be positioned within the internal space 103, on the cooling and heating plate 108, and optionally within individual compartments formed by dividers 134. Sensor data is continuously or periodically provided to the controller 116 to determine the current thermal state of the cooler.

Based on user-selected setpoints entered through the screen 126, buttons 128, or the mobile application 124, the controller 116 selectively supplies electrical current to one or more thermoelectric modules 114a–114d. The magnitude and direction of the current determine whether a given thermoelectric module operates in a cooling mode or a heating mode.

In certain embodiments, the controller 116 independently controls each thermoelectric module 114a–114d. This independent control enables localized thermal regulation across different regions of the cooling and heating plate 108, particularly when the internal space 103 is divided into multiple compartments by dividers 134. As a result, different compartments may be maintained at different temperatures simultaneously, including configurations where one compartment is cooled while another compartment is heated.

The controller 116 may regulate power delivery to the thermoelectric modules using pulse-width modulation, proportional–integral–derivative control, or other closed-loop control techniques to maintain temperature stability while minimizing power consumption. The controller may further adjust fan speeds of the fans 112a–112d based on heat sink temperature, ambient temperature, or operating mode.

Power source selection and management are also governed by the controller 116. When sufficient solar energy is available, electrical power generated by the solar panel 104 may be used directly to operate the thermoelectric modules and/or charge the power supply 118. When solar energy is unavailable or insufficient, the controller automatically transitions operation to battery power. When external alternating current power is supplied through the power supply module 120, the controller may prioritize operation from the external source while charging the battery. The power supply module 120 may be configured to receive standard residential or commercial alternating current power, including approximately 110–120 volts or 220–240 volts, and convert the alternating current into direct current for operating the thermoelectric modules and charging the rechargeable battery.

The controller 116 may further implement predefined operating modes, such as a rapid-cool mode in which increased power is temporarily supplied to the thermoelectric modules to quickly reach a target temperature, and an energy-saving mode in which power delivery is reduced once the target temperature is achieved. Alerts and status information may be communicated to the user locally via the screen 126 or remotely via the transceiver 122 and mobile application 124.

Conventional insulated coolers rely on passive thermal retention using ice or frozen packs and lack any active temperature regulation. Some coolers are known to be powered by a single electrical source, such as a vehicle outlet or wall power, and are not suitable for sustained off-grid operation.

The present thermoelectric cooler differs from known systems by integrating a hybrid power architecture that combines a solar panel, a rechargeable battery, and an external alternating current power source under unified controller logic. This configuration enables continuous, autonomous operation across a wide range of environments without requiring user intervention to switch power sources.

Further, prior coolers typically employ a single cooling zone and a localized cooling interface, resulting in uneven temperature distribution and limited functionality. In contrast, the present invention employs multiple independently controlled thermoelectric modules coupled to a distributed cooling and heating plate housed within the lid. This architecture enables uniform temperature distribution and, in certain embodiments, simultaneous multi-zone heating and cooling within a single cooler body.

The placement of the thermoelectric modules, heat sinks, fans, and insulation within the lid represents a structural departure from known designs that mount cooling components through sidewalls or rear panels. By housing the thermal management system within the lid, the present invention preserves usable internal storage volume, simplifies airflow management, and enables modular scalability without increasing the footprint of the cooler.

Additionally, the integration of removable dividers in combination with independently controlled thermoelectric modules provides functionality not found in conventional portable coolers. The ability to thermally isolate compartments and maintain different temperature conditions within the same enclosure addresses use cases that are not contemplated by prior art systems, which typically require separate appliances to achieve similar results.

Accordingly, the combination of hybrid renewable power management, lid-integrated thermoelectric architecture, intelligent control logic, and multi-zone temperature capability provides technical advantages that are not achieved by simple aggregation of known cooler components. These features cooperate to deliver a portable cooling and heating system with capabilities and efficiencies not suggested by existing insulated coolers, plug-in devices, or compressor-based portable refrigerators.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A thermoelectric cooler, comprising:
a body defining an internal storage space;
a lid coupled to the body and movable between an open position and a closed position;
at least one thermoelectric module having a cold side and a hot side;
a cooling plate in thermal communication with the cold side of the thermoelectric module and oriented toward the internal storage space when the lid is closed;
a heat sink in thermal communication with the hot side of the thermoelectric module;
a rechargeable battery;
a solar panel electrically coupled to the rechargeable battery;
a power supply module configured to receive external alternating current and convert the alternating current to direct current; and
a controller configured to selectively power the thermoelectric module using electrical energy from the solar panel, the rechargeable battery, the power supply module, or combinations thereof to regulate a temperature within the internal storage space.

2. The thermoelectric cooler of claim 1, wherein the solar panel is mounted on an exterior surface of the lid.

3. The thermoelectric cooler of claim 1, wherein the controller automatically transitions between solar power, battery power, and external alternating current without user intervention.

4. The thermoelectric cooler of claim 1, wherein the rechargeable battery is removably received within a slot formed in a bottom portion of the body.

5. The thermoelectric cooler of claim 1, further comprising a user interface including a display and at least one input control configured to set a desired temperature.

6. The thermoelectric cooler of claim 1, further comprising a wireless transceiver configured to communicate operating data to a mobile application.

7. The thermoelectric cooler of claim 1, wherein the controller is configured to operate the thermoelectric module in a cooling mode or a heating mode by reversing a direction of electrical current supplied to the thermoelectric module.

8. The thermoelectric cooler of claim 1, wherein the controller is configured to regulate power supplied to the thermoelectric module using closed-loop feedback from at least one temperature sensor.

9. The thermoelectric cooler of claim 1, further comprising at least one fan configured to move air across the heat sink to enhance heat dissipation.

10. The thermoelectric cooler of claim 1, wherein the lid includes ventilation openings configured to permit airflow for heat dissipation while limiting ingress of moisture or debris.

11. A thermoelectric cooler, comprising:
a body defining an internal storage space;
a lid enclosing the internal storage space;
an insulation panel positioned within the lid;
a cooling and heating plate secured to the insulation panel and facing the internal storage space;
a plurality of thermoelectric modules positioned within the lid, each thermoelectric module having a cold side in thermal communication with the cooling and heating plate and a hot side;
a plurality of heat sinks thermally coupled to the hot sides of the thermoelectric modules; and
a controller configured to independently control electrical power supplied to each thermoelectric module.

12. The thermoelectric cooler of claim 11, wherein the cooling and heating plate extends across a majority of an interior surface of the lid.

13. The thermoelectric cooler of claim 11, further comprising a plurality of fans configured to move air across the heat sinks.

14. The thermoelectric cooler of claim 11, further comprising at least one removable divider configured to partition the internal storage space into multiple compartments.

15. The thermoelectric cooler of claim 14, wherein the controller is configured to maintain different temperatures in different compartments.

16. The thermoelectric cooler of claim 11, wherein at least one thermoelectric module operates in a heating mode while another thermoelectric module operates in a cooling mode.

17. The thermoelectric cooler of claim 11, wherein the lid includes ventilation openings configured to permit airflow for heat dissipation while limiting ingress of moisture or debris.

18. A method of controlling temperature within a thermoelectric cooler, the method comprising:
supplying electrical power to at least one thermoelectric module from a rechargeable battery;
generating electrical power using a solar panel electrically coupled to the rechargeable battery;
selectively charging the rechargeable battery using either the solar panel or an external alternating current source;
transferring heat between an internal storage space and a cooling and heating plate using the thermoelectric module; and
regulating operation of the thermoelectric module using a controller to maintain a selected temperature within the internal storage space.

19. The method of claim 18, further comprising independently controlling a plurality of thermoelectric modules to maintain different temperatures in different regions of the internal storage space.

20. The method of claim 18, further comprising reversing a direction of electrical current supplied to the thermoelectric module to selectively operate in a cooling mode or a heating mode.
